(19) United States
(12) Patent Application Publication
(10) Pub. No.: US 2013/0341826 A1
(43) Pub. Date: Dec. 26, 2013

(54) DECORATION FILM AND MANUFACTURING METHOD FOR DECORATED ARTICLE

(71) Applicants: Shih-Chiang Hu, Taoyuan County (TW); Shih-Min Huang, Taipei City (TW); Fang-Yu Su, Taoyuan County (TW)

(72) Inventors: Shih-Chiang Hu, Taoyuan County (TW); Shih-Min Huang, Taipei City (TW); Fang-Yu Su, Taoyuan County (TW)

(73) Assignee: ETANSI INC., Taoyuan County (TW)

(21) Appl. No.: 13/530,096

(22) Filed: Jun. 21, 2012

(51) Int. Cl. B29C 45/14; C09J 7/02

(52) U.S. Cl. 264/259; 428/41.8

(57) ABSTRACT

Decoration films and manufacturing methods for decorated articles are provided. One of the decoration films includes a substrate, a releasing layer formed on the substrate, an ink layer formed on whole surface of the releasing layer, and a first adhesive layer formed on part surface of the ink layer. Another one of the decoration films includes a substrate, a releasing layer formed on the substrate, and an adhesive ink layer formed on part surface of the releasing layer.

### BACKGROUND OF THE INVENTION

1. Field of the Invention

The present invention generally relates to decoration films and manufacturing methods for decorated articles.

2. Description of Related Art

Conventionally, the illustrations or decorations formed on the surface of the plastic casing are mainly fabricated by spraying process or printing process to present certain visual effect. Nevertheless, the spraying process is unfavorable in mass production for the disadvantages of time consumption and process complexity. In addition, the conventional spraying process may cause the splashing of sprays containing lead or other heavy metals so that the spraying material is wasted and the problem of pollution is caused. Furthermore, during the spraying process, the mass of the coating material is not easily controlled so that the thickness is usually uneven. Particularly, when the spraying process is performed on the curve portion of the casing, the improper accumulation of the coating material is worse.

To solve the abovementioned problem, an in-mold decoration (IMD) technique is provided. The process of the IMD technique includes placing a film has predetermined decorations into the mold of the injection machine, injecting a melted plastic material at a side of the film in the mold so that the melted plastic material and the film are combined to form a decorated casing, and thereafter ejecting the decorated casing from the mold. Accordingly, the in-mold decoration process is completed.

FIG. 1 illustrates a casing during the in-mold decoration process. Please refer to FIG. 1, the casing 50 is a part of a notebook computer and has an opening 52 for accommodating a keyboard module. A waste block 54 is arranged in the opening 52 and connected to the injection head 60. Once the casing 50 is formed, the waste block 54 is removed with the injection head 60. However, the waste block 54 is adhered to an adhesive layer 72 of a decoration film 70 in the opening 52. In fact, the adhesive layer 72 covers whole surface of the decoration film 70. Therefore, the decoration film 70 in the opening 52 will be dragged to be broken and forms irregular edge by the injection head 60. It costs additional time to remove the residual decoration film 70 in the opening 52.

### SUMMARY OF THE INVENTION

Accordingly, the present invention is directed to a decoration film having patterned adhesive layer.

The present invention is directed to a manufacturing method for a decorated article with lower cost.

A decoration film of the present invention includes a substrate, a releasing layer formed on the substrate, an ink layer formed on whole surface of the releasing layer, and a first adhesive layer formed on part surface of the ink layer.

In one embodiment of the present invention, the decorated film is configured to be attached to a casing. The casing has a first opening. The first adhesive layer has a second opening. The second opening of the first adhesive layer is completely overlapped by the first opening while the decorated film is attached to the casing. A shape of the first opening can be identical to a shape of the second opening. Meanwhile, size of the first opening can be identical to size of the second opening. Otherwise, size of the first opening can be larger than size of the second opening. Moreover, the first opening and the second opening can be concentric. Furthermore, a distance between an edge of the first opening and an edge of the second opening can be smaller than or equal to 1 centimeter.

In one embodiment of the present invention, the decorated film further includes a durable layer formed between the releasing layer and the ink layer, and a second adhesive layer formed between the durable layer and the ink layer.

Another decoration film of the present invention includes a substrate, a releasing layer formed on the substrate, and an adhesive ink layer formed on part surface of the releasing layer.

In one embodiment of the present invention, the decorated film is configured to be attached to a casing. The casing has a first opening. The adhesive ink layer has a second opening. The second opening of the adhesive ink layer is completely overlapped by the first opening while the decorated film is attached to the casing. A shape of the first opening can be identical to a shape of the second opening. Meanwhile, size of the first opening can be identical to size of the second opening. Otherwise, size of the first opening can be larger than size of the second opening. Moreover, the first opening and the second opening can be concentric. Furthermore, a distance between an edge of the first opening and an edge of the second opening can be smaller than or equal to 1 centimeter.

In one embodiment of the present invention, the decorated film further includes a durable layer formed between the releasing layer and the adhesive ink layer.

A manufacturing method for a decorated article of the present invention includes following steps. Providing a decoration film including a substrate, a releasing layer formed on the substrate, an ink layer formed on whole surface of the releasing layer, and a first adhesive layer formed on part surface of the ink layer. Feeding the decoration film into a mold with the substrate in contact with an inner surface of the mold. Injecting a plastic material into the mold through an injection head for forming an article body in the mold. The injection head is aligned with a region of the decoration film far away from the first adhesive layer. Taking the article body with the decoration film out from the mold. Simultaneously removing both the substrate and the releasing layer.

Another manufacturing method for a decorated article of the present invention includes following steps. Providing a decoration film including a substrate, a releasing layer formed on the substrate, and an adhesive ink layer formed on part surface of the releasing layer. Feeding the decoration film into a mold with the substrate in contact with an inner surface of the mold. Injecting a plastic material into the mold through an injection head for forming an article body in the mold. The injection head is aligned with a region of the decoration film far away from the adhesive ink layer. Taking the article body with the decoration film out from the mold. Simultaneously removing both the substrate and the releasing layer.

As described above, the present invention provides a decoration film with an adhesive ink layer only formed on part surface of the releasing layer. The injection head can be aligned with a region of the decoration film far away from the adhesive layer. Therefore, the injection head for manufacturing the decorated article will not be adhered to the decoration film, so as to avoid dragging the decoration film

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a casing during the in-mold decoration process.

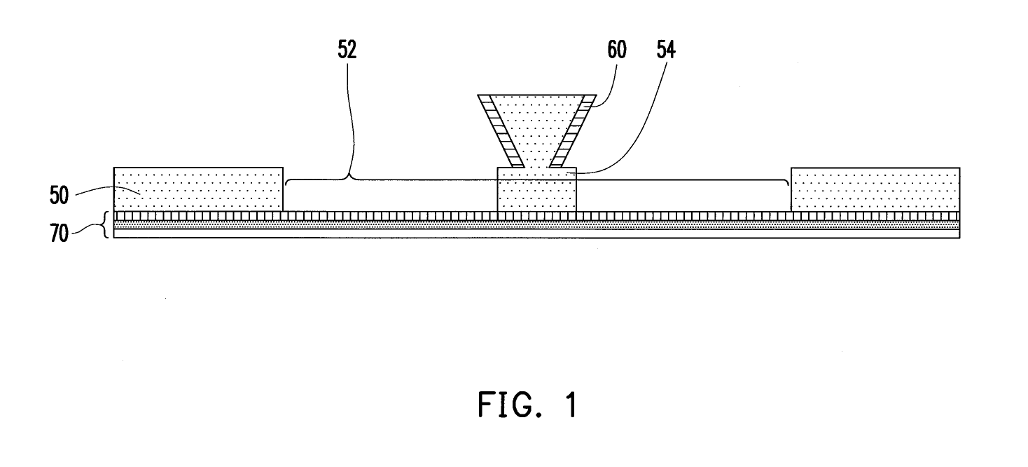

FIG. 2 is a cross-section view of a decoration film of an embodiment of the present invention.

FIG. 3 illustrates a manufacturing method for a decorated article of an embodiment of the present invention.

FIG. 4 illustrates a decorated film of another embodiment of the present invention in the manufacturing process.

FIG. 5 illustrates a decorated film of another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

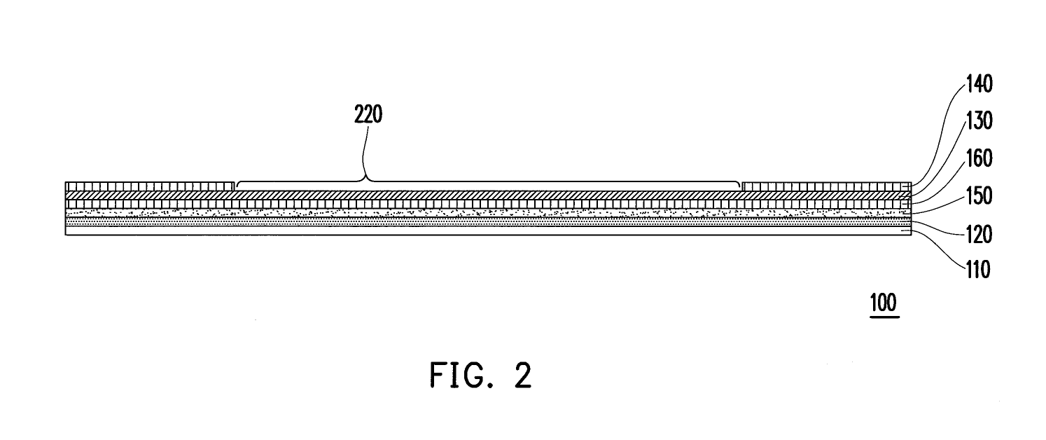

FIG. 2 is a cross-section view of a decoration film of an embodiment of the present invention. Please refer to FIG. 2, a decoration film 100 of the present embodiment includes a substrate 110, a releasing layer 120 formed on the substrate 110, an ink layer 130 formed on whole surface of the releasing layer 120, and an adhesive layer 140 formed on part surface of the ink layer 130. That is, the adhesive layer 140 is patterned and has an opening 142. Therefore, the surface of the decoration film 100 is not completely adhesive. The decoration film 100 of the present embodiment can be easily attached to an article to be decorated with lower cost and shorter work time.

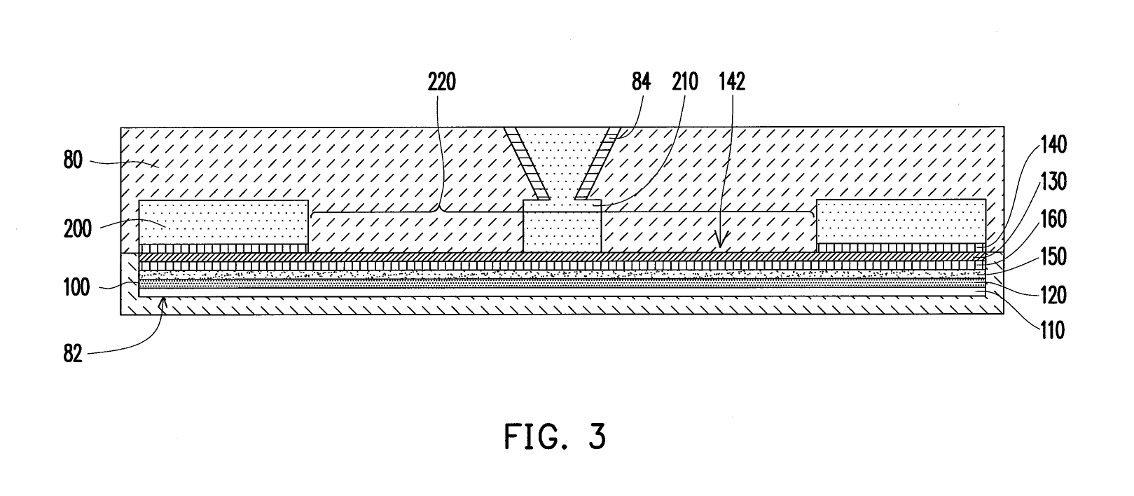

FIG. 3 illustrates a manufacturing method for a decorated article of an embodiment of the present invention. Please refer to FIG. 3, the manufacturing method for a decorated article of the present embodiment includes following steps. The decoration film 100 as shown in FIG. 2 is provided. Thereafter, the decoration film 100 is fed into a mold 80 with the substrate 110 in contact with an inner surface 82 of the mold 80. Afterward, a plastic material is injected into the mold 80 through an injection head 84 for forming an article body 200 in the mold 80. The injection head 84 is aligned with a region of the decoration film 100 far away from the adhesive layer 140. In other word, the injection head 84 is located above the opening 142 of the adhesive layer 140. Therefore, a waste block 210 connected to the injection head 84 does not adhered to the adhesive layer 140 of the decoration film 100.

After the article body 200 is formed in the mold 80, the article body 200 with the decoration film 100 adhered thereto is took out from the mold 80. The article body 200 of the present embodiment has an opening 220. While the article body 200 is took out from the mold 80, the injection head 84 and the waste block 210 leave the decoration film 100 without dragging the decoration film 100. Thereafter, both the substrate 110 and the releasing layer 120 are simultaneously removed from the article body 200. Consequently, the ink layer 130 can be firmly adhered to the article body 200 via the adhesive layer 140, and the ink layer 130 in the opening 220 of the article body 200 can be removed easily and precisely.

In the present embodiment, the decorated film 100 of FIG. 2 is configured to be attached to a casing (e.g., the article body 200 of FIG. 3). The article body 200 of FIG. 3 can be a casing of a notebook computer, mobile phone or any other product that needs an opening and a decorated surface. The opening 142 of the adhesive layer 140 is completely overlapped by the opening 220 of the article body 200 while the decorated film 100 is attached to the article body 200. A shape of the opening 142 can be identical to a shape of the opening 220, such as a rectangular, a circle or any other shape. In the present embodiment, size of the opening 142 is identical to size of the opening 220. Moreover, the opening 142 and the opening 220 can be concentric.

The decorated film 100 of the present embodiment further includes a durable layer 150 formed between the releasing layer 120 and the ink layer 130 and an adhesive layer 160 formed between the durable layer 150 and the ink layer 130. The material of the durable layer 150 can be radiant curable multifunctional acrylate, epoxide, vinyl ester resin, diallyl phthalate, or vinyl ether, or a combination of the aforementioned materials. Radiant curable multifunctional acrylate can be any one of the following kinds: epoxy acrylate, polyurethane acrylate, polyester acrylate, siloxane acrylate, or glycidyl acrylate. The opening 142 of the adhesive layer 140 can be formed by stencil printing the adhesive layer 140 or other suitable method, and the opening 142 can be multiple. Color of the ink layer 130 can be mono, multiple, gradient or any other various type.

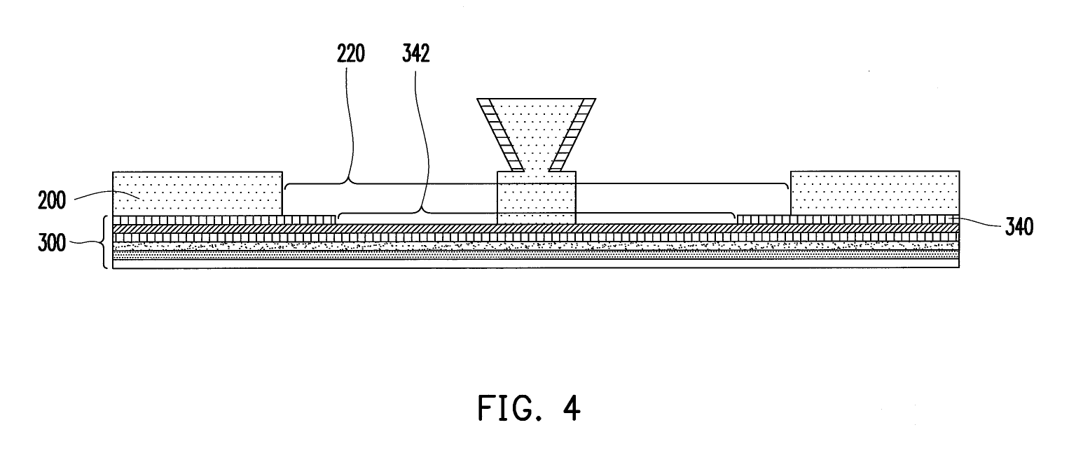

FIG. 4 illustrates a decorated film of another embodiment of the present invention in the manufacturing process. Please refer to FIG. 4, the decorated film 300 of the present embodiment is similar to the decoration film 100 of FIG. 2, only differences therebetween are explained here. Size of the opening 220 of the article body 200 is larger than size of the opening 342 of the adhesive layer 340 of the decorated film 300. The decorated film 300 having larger opening 342 can be easily aligned while being transferred to a casing. A distance between an edge of the opening 220 of the article body 200 and the opening 342 of the adhesive layer 340 can be smaller than or equal to 1 centimeter while the opening 220 of the article body 200 and the opening 342 of the adhesive layer 340 of the decorated film 300 are concentric.

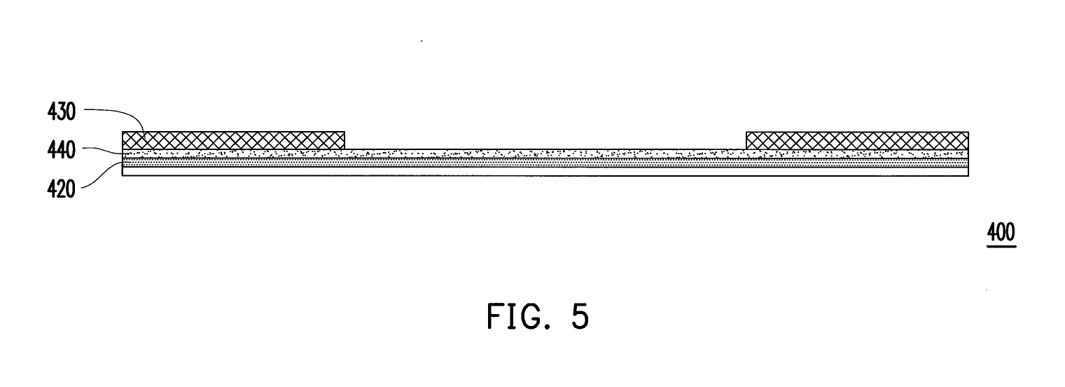

FIG. 5 illustrates a decorated film of another embodiment of the present invention. Please refer to FIG. 5, the decorated film 400 of the present embodiment is similar to the decoration film 100 of FIG. 2, only differences therebetween are explained here. An adhesive ink layer 430 substitutes for the adhesive layer 140 and the ink layer 130 of the decoration film 100. The adhesive ink layer 430 is formed above part surface of the releasing layer 420. The adhesive ink layer 430 is a mixture of adhesive material and ink. Therefore, the surface of the decoration film 400 is not completely adhesive. A durable layer 450 is formed between the releasing layer 420 and the adhesive ink layer 430. Another manufacturing method for a decorated article of the present invention that applies the decoration film 400 is similar to the method shown in FIG. 3.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decoration film comprising:
a substrate;
a releasing layer formed on the substrate;
an ink layer formed on whole surface of the releasing layer; and
a first adhesive layer formed on part surface of the ink layer.

2. The decorated film according to claim 1 is configured to be attached to a casing, wherein the casing has a first opening, the first adhesive layer has a second opening, the second opening of the first adhesive layer is completely overlapped by the first opening while the decorated film is attached to the casing.

3. The decorated film according to claim 2, wherein a shape of the first opening is identical to a shape of the second opening.

4. The decorated film according to claim 3, wherein size of the first opening is identical to size of the second opening.

5. The decorated film according to claim 3, wherein size of the first opening is larger than size of the second opening.

6. The decorated film according to claim 5, wherein the first opening and the second opening are concentric.

7. The decorated film according to claim 6, wherein a distance between an edge of the first opening and an edge of the second opening is smaller than or equal to 1 centimeter.

8. The decorated film according to claim 1 further comprising:
a durable layer formed between the releasing layer and the ink layer; and
a second adhesive layer formed between the durable layer and the ink layer.

9. A decoration film comprising:
a substrate;
a releasing layer formed on the substrate; and
an adhesive ink layer formed on part surface of the releasing layer.

10. The decorated film according to claim 9 is configured to be attached to a casing, wherein the casing has a first opening, the adhesive ink layer has a second opening, the second opening of the adhesive ink layer is completely overlapped by the first opening while the decorated film is attached to the casing.

11. The decorated film according to claim 10, wherein a shape of the first opening is identical to a shape of the second opening.

12. The decorated film according to claim 11, wherein size of the first opening is identical to size of the second opening.

13. The decorated film according to claim 11, wherein size of the first opening is larger than size of the second opening.

14. The decorated film according to claim 13, wherein the first opening and the second opening are concentric.

15. The decorated film according to claim 14, wherein a distance between an edge of the first opening and an edge of the second opening is smaller than or equal to 1 centimeter.

16. The decorated film according to claim 9 further comprising a durable layer formed between the releasing layer and the adhesive ink layer.

17. A manufacturing method for a decorated article comprising:
providing a decoration film comprising:
a substrate;
a releasing layer formed on the substrate;
an ink layer formed on whole surface of the releasing layer;
a first adhesive layer formed on part surface of the ink layer;
feeding the decoration film into a mold with the substrate in contact with an inner surface of the mold;
injecting a plastic material into the mold through an injection head for forming an article body in the mold, wherein the injection head is aligned with a region of the decoration film far away from the first adhesive layer;
taking the article body with the decoration film out from the mold; and
simultaneously removing both the substrate and the releasing layer.

18. A manufacturing method for a decorated article comprising:
providing a decoration film comprising:
a substrate;
a releasing layer formed on the substrate;
an adhesive ink layer formed on part surface of the releasing layer;
feeding the decoration film into a mold with the substrate in contact with an inner surface of the mold;
injecting a plastic material into the mold through an injection head for forming an article body in the mold, wherein the injection head is aligned with a region of the decoration film far away from the adhesive ink layer;
taking the article body with the decoration film out from the mold; and
simultaneously removing both the substrate and the releasing layer.
